(19) United States
(12) Patent Application Publication
(10) Pub. No.: US 2005/0151635 A1
(43) Pub. Date: Jul. 14, 2005

(54) External opening control for doors and the like

(76) Inventors: Frederic Burkat, Bouzy La Foret (FR); Jean-Marc Belmond, St. Jean Le Blanc (FR); Emmanuel Huber, Chateauneuf Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 11/030,568

(22) Filed: Jan. 6, 2005

(30) Foreign Application Priority Data
Jan. 9, 2004 (FR) 04 00 178

(51) Int. Cl. E05D 15/50

(52) U.S. Cl. 340/445

(57) ABSTRACT

An opening control for a vehicle door or the like includes a handle movable in two directions, a first sensor operated by moving the handle in one direction, and a second sensor operated by moving the handle in the other direction. The sensors output a door opening signal to release a lock and open the vehicle door when the handle is moved in either of the two directions. The opening control can be operated in one direction, for example, by pulling the handle with a hand but also can be operated in a further direction, for example, by pushing against the handle with the body if the user's hands are not free. This avoids the need for the user to have a hand free when opening the vehicle door.

### REFERENCE TO RELATED APPLICATION

This application claims priority to French patent application No. 04 00 178 filed Jan. 9, 2004.

### BACKGROUND OF THE INVENTION

The invention relates generally to an external opening control for an openable member, such as a door of a vehicle.

A lock maintains an openable member of an automobile vehicle in a closed position. It is also responsible for releasing a catch to open the openable member following actuation of an external opening control linked to the lock. When the user's arms and hands are full, it can be difficult to actuate the external opening control.

There is consequently a need for an external opening control that is easily actuated, even when the user's hands are full.

### SUMMARY OF THE INVENTION

The present invention provides a door opening control including a handle movable in two directions, a first sensor operated by moving the handle in one direction, and a second sensor operated by moving the handle in the other direction. The sensors output a door opening signal when the handle is moved in either of the two directions. Preferably, the sensors are piezoelectric sensors.

The control can further include a module, and the handle is movable with respect to the module. The sensors are preferably carried by the module. The handle is preferably rotatable in the two directions.

An openable member of a vehicle also includes a control logic and an external opening control. The sensors output an opening signal for the openable member to the control logic when the handle is moved in either of the two directions.

The openable member preferably further includes an electrical lock actuated by the control logic. Preferably, the lock additionally includes an engageable/disengageable mechanical release feature. In a preferred embodiment, the openable member is opened electrically after the sensors trigger the opening signal.

Further characteristics and advantages of the invention will become clearer from the following detailed description of some embodiments of the invention provided solely by way of example and with reference to the FIGURE.

### BRIEF DESCRIPTION OF DRAWINGS

FIG. 1 illustrates a diagrammatic view of an external opening control.

### DETAILED DESCRIPTION OF PREFERRED EMBODIMENTS

The invention provides a vehicle door external opening control including a handle movable in two directions and sensors each operated by movement of the handle in one of the direction. The control can be actuated in one direction, for example, by pulling on the handle with a hand and can be actuated in another direction, for example, by pushing against the handle with the body if the user's hands are full. This avoids the need for the user to free one of his hands to operate the opening control. It also simplifies actuation of the handle.

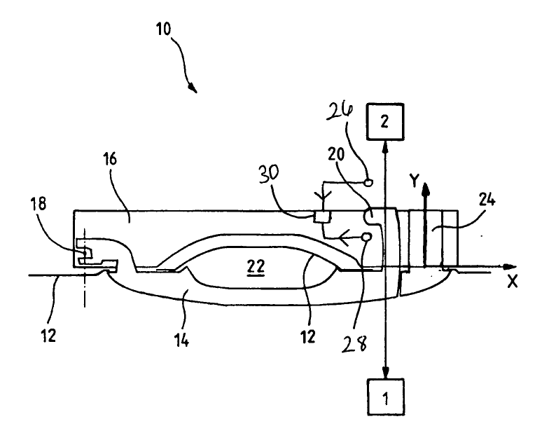

FIG. 1 shows an external opening control 10. The opening control 10 makes it possible to actuate a lock of an openable member from outside a vehicle. The opening control 10 is built into the openable member of the vehicle, and an outer door skin 12 is shown. The opening control 10 includes a handle 14 and a module 16. The handle 14 is outside the vehicle and is movable with respect to the module 16, which is immovably mounted in the openable member. The opening control 10 can consequently be installed as a unitary block into the openable member.

In FIG. 1, direction X shows the longitudinal direction of the vehicle, in particular towards the rear of the vehicle. Direction Y is the direction crosswise to the vehicle in the plane the vehicle moves in, in particular towards the inside of the vehicle.

In one example, the openable member is a vehicle door. However, the term also covers other parts of the vehicle, such as a hatchback door or a trunk lid. The vehicle door is maintained closed by a lock. The lock is typically mounted on the door and is actuated by the user operating on the external opening control.

The lock is, for example, electric, and a motor electrically opens the door lock. The motor can be electrically powered by the main electrical circuit of the vehicle, and it is dimensioned to ensure the door lock opens under normal operating conditions.

Further, the lock can include an engageable mechanical opening feature. Mechanical opening allows the vehicle door to be opened even if the electric power supply of the vehicle fails. This may occur after an accident when the electrical supply is interrupted, but the vehicle door can still be opened. Operation of the handle 14 of the opening control 10 operates on a cable or a mechanical system of rods that are connected to the lock, thereby opening the door lock.

The handle 14 can be moved with respect to the module 16 and rotationally moves about an axis 18. The handle 14 is movable in a first direction 1. Depending on the case, the handle 14 can be moved by the user grasping the handle 14 and pulling it towards the user in the opposite direction to the direction Y. The vehicle door then accompanies the movement performed by the user. The rotary movement of the handle 14 about the axis 18 can be limited by a shoulder 20 which abuts the module 16. A space 22 between the handle 14 and the outer door skin 12 allows the user to introduce a hand and grasp and pull the handle 14. When the handle 14 is not pulled, the shoulder 20 in the vehicle door can be approximately 20 mm from the outer door skin 12, which is a sufficient distance over which the handle 14 moves the lock mechanically via the cable or the system of rods.

The handle 14 can also be moved in a second direction 2. In this direction, the handle 14 can be shifted by the user who pushes on the handle 14 in the direction Y. Pressure exercised towards the openable member moves the handle 14 in the second direction 2. The movement can be achieved by rotation of the handle 14 about the axis 18. The rotation is in the opposite direction to the movement in the first direction 1, simplifying the mechanics of the movement of the handle 14 by taking advantage of the rotary mounting of the handle 14 in the first direction 1. The movement in the second direction 2 can be exercised on the handle 14 by the user's body. For example, the user can press a hip against the handle 14. The handle 14 moves in the direction Y, for example, over a distance of approximately 5 mm, allowing actuation of a second sensor 28. This allows the second sensor 28 to be operated without necessarily ensuring a large degree of movement of the handle 14. In particular, the shoulder 20 can move approximately 5 mm.

The opening control 10 further includes a first sensor 26 that is operated by the movement of the handle 14 in the first direction 1 and the second sensor 28 that is operated by the movement of the handle 14 in the second direction 2. The sensors 26 and 28 each output an opening signal when the handle 14 moves in either direction. The sensors 26 and 28 supply a signal expressing the user's desire to open the vehicle door. The signal actuates the electric motor, and the lock and the door are opened electrically. The openable member is opened electrically via the opening signal from the sensors 26 and 28. Electrical door opening allows the user to open the door when the user's hands are full. The sensors 26 and 28 are typically piezoelectric sensors. Deformation of the sensors 26 and 28 by movement of the handle 14 in either direction sends an electrical signal representing that the vehicle door is to be opened.

The sensors 26 and 28 are, for example, carried by the module 16, facilitating mounting of the sensors 26 and 28, notably during assembly of the opening control 10. The sensors 26 and 28 are, for example, arranged facing the shoulder 20 and are actuated by movement of the shoulder 20, which changes position with respect to the module 16.

The vehicle door can include a control logic 30, and the sensors 26 and 28 supply an openable member release signal to the control logic 30. The control logic 30 centralizes the sensor 26 and 28 signals. When a signal output from one of the sensors 26 and 28 is received, the control logic 30 energizes the electric lock and starts the electric motor for releasing the lock and opening the vehicle door. The control logic 30 can be separate from the opening control 10 in the openable member and can also be mounted in the module 16 to facilitate assembly of the control logic 30, notably by simultaneous assembly with the opening control 10.

In FIG. 1, the opening control 10 can further include a locking cylinder 24, making it possible to disengage the door lock (for security locking/release of security locking) and prevent the door lock from being opened.

The opening control 10 operates as follows. When the user has a hand free, he can grasp the handle 14 and pull it towards him in the opposite direction to the direction Y. The handle 14 rotates about the axis 18, thereby acting on the first sensor 26. The first sensor 26 outputs a signal to the control logic 30, which initiates electrical release of the lock and opens the vehicle door via the electric motor. When the user's hand is not free, he can act on the handle in the direction Y. He can, for example, push the handle 14 with his hip. The moving handle 14 thus acts on the second sensor 28. The second sensor 28 outputs a signal to the control logic 30, which also initiates electrical release of the lock and opens the vehicle door via the electric motor. The lock and the vehicle door can also each have an electric motor to open them.

Further, the vehicle door can also be opened mechanically to ensure the vehicle door can be opened when the electrical supply to the electrical control is unavailable. The user then continues the rotary movement of the handle 14 beyond sensor activation, releasing the lock via the cable or the system of rods. The rotary movement of the handle 14 about the axis 18 is limited by the shoulder 20 abuting against, for example, the module 16.

Clearly, this invention is not limited to the embodiments described by way of example. Thus, one could envision using one single sensor to detect door movement in either direction.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A door opening control comprising:
a handle movable in a first direction and a second direction;
a first sensor operated by moving the handle in the first direction; and
a second sensor operated by moving the handle in the second direction, wherein the first sensor and the second sensor send a door opening signal when the handle is moved in the first direction and the second direction, respectively.

2. The control according to claim 1, wherein the first sensor and the second sensor are piezoelectric sensors.

3. The control according to claim 1, further comprising a module, and the handle is movable with respect to the module.

4. The control according to claim 3, wherein the first sensor and the second sensor are carried by the module.

5. The control according to claim 1, wherein the handle is rotatable in the first direction and the second direction.

6. An openable member of a vehicle comprising:
a control logic; and
an external door opening control including a handle movable in a first direction and a second direction, a first sensor operated by moving the handle in the first direction, and a second sensor operated by moving the handle in the second direction,
wherein the first sensor and the second sensor send an opening signal for the openable member to the control logic when the handle is moved in the first direction and the second direction, respectively.

7. The openable member according to claim 6, further comprising an electrical lock actuated by the control logic.

8. The openable member according to claim 7, wherein the electrical lock further includes an engageable/disengageable mechanical release feature.

9. The openable member according to claim 6, wherein the openable member is opened electrically after the opening signal is sent by one of the first sensor and the second sensor.
